(19) United States
(12) Patent Application Publication
(10) Pub. No.: US 2007/0091738 A1
(43) Pub. Date: Apr. 26, 2007

(54) Light producing digital audio signal player

(76) Inventors: Shen-Chi Liu, Tainan City (TW); Chin-Chen Ho, Rende Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/257,985

(22) Filed: Oct. 26, 2005

(51) Int. Cl. G11B 7/00

(52) U.S. Cl. 369/44.11

(57) ABSTRACT

A digital audio signal player includes a microprocessor, a light producing ring, a digital audio signal processor, a dynamic RAM, and a manually-operated turning plate; the dynamic RAM is used to store music data; the light producing ring can produce light of several different colors, and it is joined to the turning plate and electrically connected to the microprocessor; the digital audio signal processor will analyze the rhythms of high-frequency portions and low-frequency portions of the digital music data stored in the dynamic RAM, and transfer the result of analysis to the microprocessor, and in turn the microprocessor will make the light producing ring shine and flash on and off with the colors of its light varying with the rhythms of the high-frequency portions and the low-frequency portions of the digital music data stored in the dynamic RAM.

### BACKGROUND OF THE INVENTION

1. Field of the Invention

The present invention relates to a light producing digital audio signal player, more particularly one, which shine and flash on and off with the colors of its light varying with the rhythms of high-frequency portions and low-frequency portions of the music data.

2. Brief Description of the Prior Art

In order to help enhance the atmosphere in a music show or a dancehall, the DJ usually makes the music played with scratch sound effects by means of manually moving the analogue vinyl record positioned on the turntable at changing speeds and in alternate directions. As soon as the DJ stops moving the record with his hands, the record player will start playing the record in the normal way again. However, a single analogue vinyl record has very limited capacity to store music in, and a DJ has to prepare a lot of vinyl records in every event, and the records are likely to cause the DJ inconvenience due to the large size and heavy weight.

In order to overcome the above problems, referring to FIG. 4, the inventor of the present invention taught a digital audio signal player, which includes a driving IC 1, a CD driving motor 11, a CD support seat 12, an ejection motor 13, a laser pick-up 14, a laser pick-up moving motor 15, a microprocessor 2, a control panel 21, a high frequency amplifier 3, a CD digital processor 4, a digital audio signal processor 5, a dynamic random access memory (RAM) 51, a turning plate 6, a digital/analog converter 7, and a low pass filter 8.

The CD support seat 12 is provided for holding a CD, and connected to the CD driving motor 11. The driving IC 1 is electrically connected to both the CD driving motor 11 and the ejection motor 13 for activating the same; when activated, the CD driving motor 11 will turn a CD on the CD support seat 12, and the ejection motor 13 will eject the CD support seat 12 for allowing CD replacement.

When the microprocessor 2 is activated, it will make the high frequency amplifier 3 send out laser light, and make the CD digital processor 4 activate the laser pick-up 14 through the driving IC 1. The driving IC 1 will also activate the laser pick-up moving motor 15 to move the laser pick-up 14. And, the laser pick-up 14 will send a signal to the CD digital processor 4 via the high frequency amplifier 3, and the CD digital processor 4 will inform the microprocessor 2 whether the laser light has focused; if the laser light fails to focus, the microprocessor 2 will stop; if the laser light has focused successfully, the microprocessor 2 will activate the CD digital processor 4, and in turn the driving IC 1 will make the CD driving motor 11 function such that the CD positioned on the CD support seat 12 is rotated at several times the normal speed. Next, the laser pick-up 14 will read the data of the CD, and send the data to both the microprocessor 2 and the digital audio signal processor 5 via the high frequency amplifier 3 and the CD digital processor 4; thus, the digital audio signal processor 5 will store the data of the CD into the dynamic RAM 51. And, the microprocessor 2 will also make the control panel 21 show information about the music contents of the CD.

To play music with the digital audio signal player, the digital audio signal processor 5 will transfer the data stored in the dynamic RAM 51 to the digital/analog converter 7 such that the data are converted into analogous ones. Next, the analogous data are transferred through the low pass filter 8, and played. To produce scratch sound effects, which are similar to those produced when a vinyl record is manually rotated, by means of using the digital audio signal player, the user has to rotate the turning plate 6 manually; thus, data relating to movement of the turning plate 6 will be transferred to the digital audio signal processor 5, and the music data stored in the dynamic RAM 51 will be transferred to the digital/analog converter 7 according to the rotational speed and direction of the turning plate 6, and in turn music will be played and with scratch sound effects. Therefore, the digital audio signal player is convenient to use, and disk jockeys like to use such digital audio signal players to play music in dancehalls.

Besides fast rhythm music, flashing light in various colors is also an important factor in enhancing the atmosphere in a dancehall. However, the digital audio signal player can't produce light to help enhance atmosphere. Therefore, there is still room for improvement in respect of the above digital audio signal player.

### SUMMARY OF THE INVENTION

It is a main object of the present invention to provide an improvement on a digital audio signal player, which can shine in such a way as to help enhance the atmosphere in a dancehall. The digital audio signal player of the present invention includes a microprocessor, a light producing ring, a digital audio signal processor, a dynamic RAM, and a manually-operated turning plate. Digital music data are stored in the dynamic RAM. The light producing ring can produce light of several different colors, and it is joined to the turning plate and electrically connected to the microprocessor. The digital audio signal processor will analyze the rhythms of high-frequency portions and low-frequency portions of the digital music data stored in the dynamic RAM, and transfer the result of analysis to the microprocessor, and in turn the microprocessor will make the light producing ring shine and flash on and off with the colors of its light varying with the rhythms of the high-frequency portions and the low-frequency portions of the digital music data.

### BRIEF DESCRIPTION OF THE DRAWINGS

The present invention will be better understood by referring to the accompanying drawings, wherein:

FIG. 1 is a circuit block diagram of the digital audio signal player in the present invention,

FIG. 2 is a perspective view of a first preferred embodiment of a digital audio signal player in the present invention,

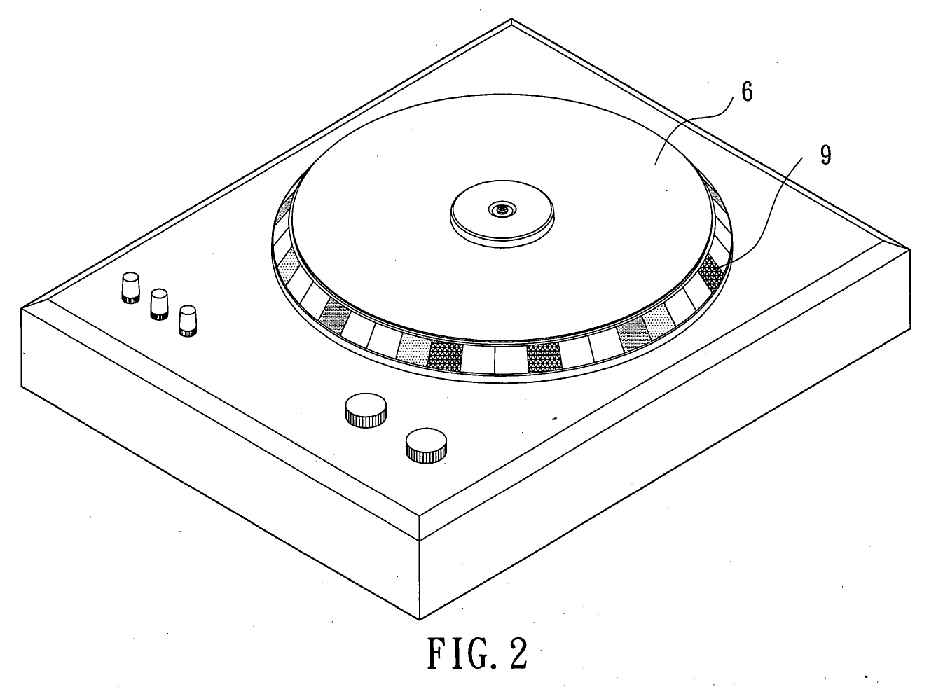

FIG. 3 is a perspective view of the second embodiment, and

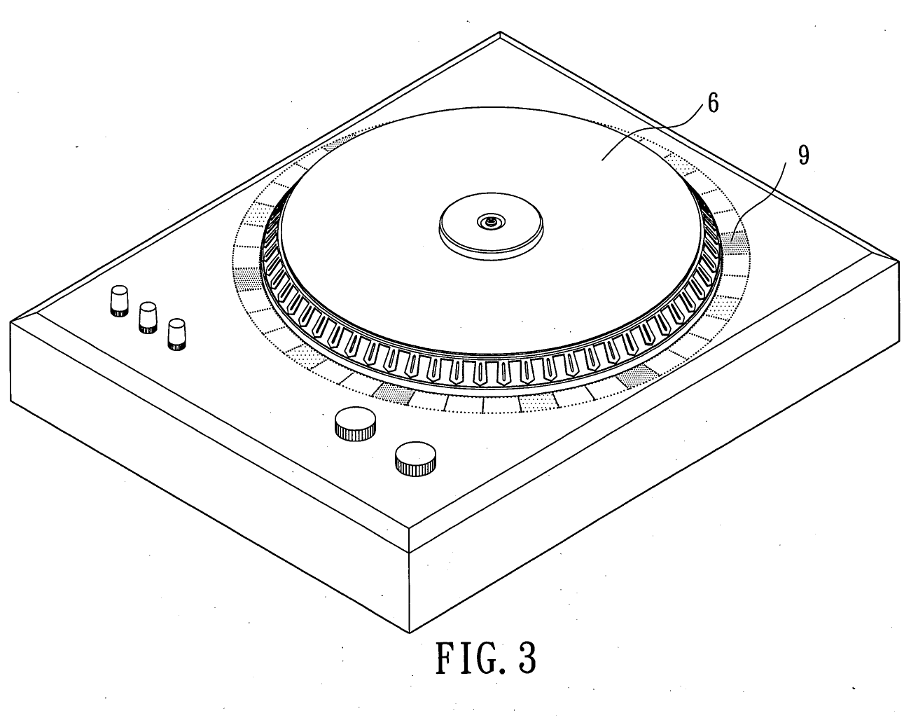

FIG. 4 is a circuit block diagram of the currently existing digital audio signal player.

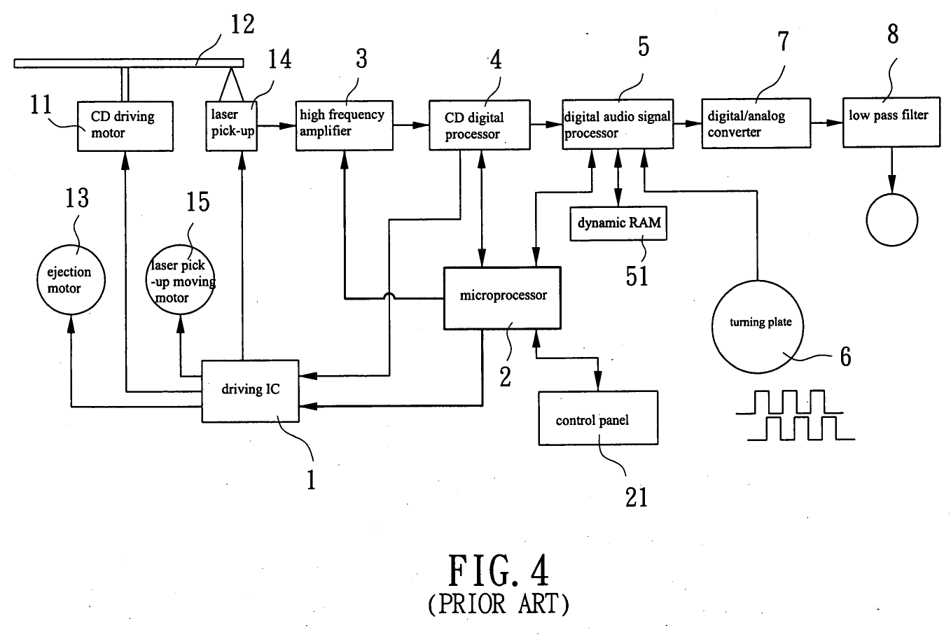

### DETAILED DESCRIPTION OF THE PREFERRED EMBODIMENTS

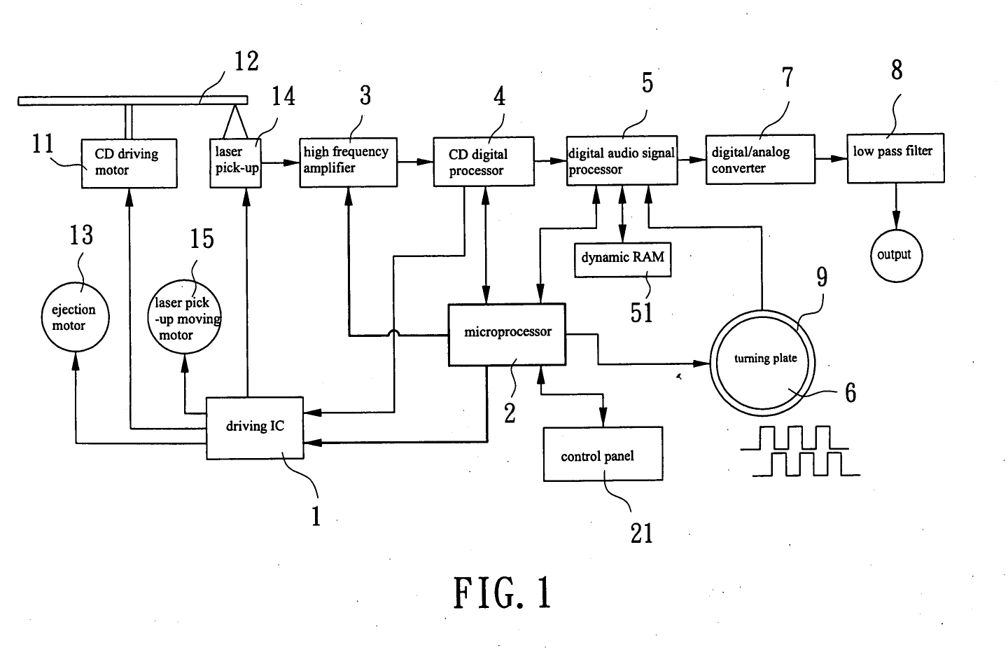

Referring to FIG. 1, a preferred embodiment of a light producing digital audio signal player of the invention includes a driving IC 1, a CD driving motor 11, a CD support seat 12, an ejection motor 13, a laser pick-up 14, a laser pick-up moving motor 15, a microprocessor 2, a control panel 21, a high frequency amplifier 3, a CD digital processor 4, a digital audio signal processor 5, a dynamic random access memory (RAM) 51, a turning plate 6, a digital/analog converter 7, a low pass filter 8, and a light producing ring 9.

The light producing ring 9 includes several light sources capable of producing light of different colors. The light producing ring 9 is secured on the turning plate 6, and electrically connected to the microprocessor 2. Or alternatively, the light producing ring 9 can be secured around the turning plate 6.

The CD support seat 12 is provided for holding a CD, and connected to the CD driving motor 11. The driving IC 1 is electrically connected to both the CD driving motor 11 and the ejection motor 13 for activating the same; when activated, the CD driving motor 11 will turn a CD on the CD support seat 12, and the ejection motor 13 will eject the CD support seat 12 for allowing change of CD.

When the microprocessor 2 is activated, it will make the high frequency amplifier 3 send out laser light, and make the CD digital processor 4 activate the laser pick-up 14 through the driving IC 1. The driving IC 1 will also activate the laser pick-up moving motor 15 to move the laser pick-up 14. And, the laser pick-up 14 will send a signal to the CD digital processor 4 via the high frequency amplifier 3, and the CD driving motor 11 will start functioning such that the CD positioned on the CD support seat 12 is rotated at several times the normal speed. Next, the laser pick-up 14 will read the data of the CD, and send the data to both the microprocessor 2 and the digital audio signal processor 5 via the high frequency amplifier 3 and the CD digital processor 4; thus, the digital audio signal processor 5 will store the data of the CD into the dynamic RAM 51. And, the microprocessor 2 will also make the control panel 21 show information about the music contents of the CD.

To play music with the digital audio signal player, the digital audio signal processor 5 will transfer the data stored in the dynamic RAM 51 to the digital/analog converter 7 such that the data are converted into analogous ones. Next, the analogous data are transferred through the low pass filter 8, and played. The user is allowed to choose a music item to be played from the digital music data stored in the dynamic RAM 51 by means of operating the turning plate 6. And, to produce scratch sound effects, which are similar to those produced when a vinyl record is manually rotated, the user has to rotate the turning plate 6 manually; thus, data relating to movement of the turning plate 6 will be transferred to the digital audio signal processor 5, and the music data stored in the dynamic RAM 51 will be transferred to the digital/analog converter 7 according to the rotational speed and direction of the turning plate 6, and in turn music will be played and with scratch sound effects.

Furthermore, the digital audio signal processor 5 will analyze the rhythms of the high-frequency portions and the low-frequency portions of the digital music data stored in the dynamic RAM 51, and transfer the result of analysis to the microprocessor 2, and in turn the microprocessor 2 will make the various light sources of the light producing ring 9, which can produce different colors of light, flash on and off according to the rhythms. Therefore, the light producing ring 9 will shine with the colors of its light varying with the rhythms of the high-frequency portions and the low-frequency portions of the digital music data stored in the dynamic RAM 51.

From the above description, it can be easily seen that besides playing music with scratch sound effects, the present digital audio signal player can shine with the colors of it light varying with the rhythms of the music data, thus helping enhance the lighting effects in a dancehall.

What is claimed is:

1. A light producing digital audio signal player, comprising
a CD support seat for supporting a CD;
a microprocessor;
a high frequency amplifier connected to the microprocessor;
a CD digital processor electrically connected to the high frequency amplifier and the microprocessor;
a digital audio signal processor electrically connected to the CD digital processor and the microprocessor;
a laser pick-up; the CD supported on the CD support seat being going to rotate, and the laser pick-up being going to read the CD when the microprocessor starts functioning; after reading the CD, the laser pick-up being going to transfer music data in the CD to the microprocessor and the digital audio signal processor via both the high frequency amplifier and the CD digital processor;
a control panel electrically connected to the microprocessor for showing information about a CD being read with the laser pick-up;
a dynamic RAM electrically connected to the digital audio signal processor; when the laser pick-up reads a CD, music data in the CD being going to be stored into the dynamic RAM;
a manually-operated turning plate electrically connected to the digital audio signal processor; when the turning plate is operated, data in respect of rotational speed and direction thereof being going to be transferred to the digital audio signal processor; the digital audio signal processor being going to choose a music item from digital music data stored in the dynamic RAM and make the chosen music item transferred from the dynamic RAM in a way according to rotational speed and direction of the turning plate; and
a light producing ring capable of producing light of a plurality of different colors; the light producing ring being joined to the turning plate and electrically connected to the microprocessor; the light producing ring being going to shine and flash on and off with colors of its light varying with rhythms of high-frequency portions and low-frequency portions of digital music data stored in the dynamic RAM.

2. The light producing digital audio signal player as claimed in claim 1, wherein the light producing ring is secured on the turning plate.

3. The light producing digital audio signal player as claimed in claim 1, wherein the light producing ring is secured around the turning plate.
